(19) United States
(12) Patent Application Publication
(10) Pub. No.: US 2003/0031011 A1
(43) Pub. Date: Feb. 13, 2003

(54) T-bar ceiling light fixture

(76) Inventors: Jack V. Miller, Seaford, DE (US); Ruth E. Miller, Seaford, DE (US)

Correspondence Address: JACK V. MILLER, 20915 Sussex Highway 13, Seaford, DE, 19973, US

(21) Appl. No.: 09/922,611

(22) Filed: Aug. 6, 2001

(51) Int. Cl. F21S 8/00

(52) U.S. Cl. 362/150; 362/223; 362/247; 362/293; 362/260

(57) ABSTRACT

A lighting fixture includes a fixture housing comprising a downward-facing concave reflector with elongated legs attachable to T-bar runners in a suspended ceiling grid, with one or more lampholders for supporting lamps in the reflector and connecting the lamps to a power source.

In a first preferred embodiment lamps of two different wattages are used in medium screw-base lampholders to provide 3-level operation from two switched circuits.

In a second preferred embodiment the fixture housing is substantially smaller than the size of the suspended ceiling grid and includes an ultraviolet and infrared absorbing lens substantially smaller, but thicker, than the size of a lens in the suspended ceiling grid.

### BACKGROUND

1. Field of the Invention

This invention relates to the field of lighting fixtures, and particularly for lighting fixtures for suspended ceiling T-bar grid systems. A T-bar ceiling is comprised of main runners and cross tees forming a grid capable of supporting ceiling panels, lighting lenses and lay-in lighting fixtures.

2. Description of Prior Art

Light fixtures for suspended T-bar grid ceilings are normally installed by either of two methods. One method attaches open-lamp light fixtures to the structural ceiling above a suspended grid, with light-transmitting lenses in the grid openings using light fixtures known as “strip lights”. The other method uses lay-in light fixtures, known as “troffers” having lenses within each fixture, with the troffers resting on the flanges of the T-bars. The most widely-used light source for suspended ceilings is the is very inexpensive, nominal 40 watt, 4-foot, T-8 or T-12 fluorescent lamp. The lamps are used as straight or U-shaped tubes, depending on whether the grid opening is 2×4 feet or 2×2 feet in size.

One continuing problem with both conventional fixture-mounting methods is that the lighting is uneven from grid-opening to grid-opening. Luminous ceilings should be softly and uniformly lit to achieve the benefits of a low-glare and high visibility. Another problem is that Federally-mandated power use limits often make it necessary to only light a portion of the grid openings. This results in bright squares or rectangles in an otherwise dark ceiling, which aesthetically ugly and reduces task performance by having bright localized glare sources in the room. Yet another problem in prior-art T-bar ceiling fixtures is that they are large and heavy to use and ship, with fragile metal and lenses that are subject to handling and shipping damage.

### OBJECTS OF THE INVENTION

It is a primary object of the present invention to provide a T-bar ceiling light fixture that is not limited to a specific lamp type and size, permitting nearly any desired wattage to be installed in lay-in fixtures to produce a uniform luminous ceiling within energy limitations. It is another object of the invention to provide a T-bar ceiling light fixture that is small in size and resistant to handling and shipping damage.

### BRIEF DESCRIPTION AND ADVANTAGES OF THE PRESENT INVENTION

The objects of the invention are achieved by a lighting fixture having a fixture housing comprising a downward-facing concave reflector with elongated legs attachable to T-bar runners in a suspended ceiling grid. The fixture housing is substantially smaller than the size of the suspended ceiling grid, having an area of approximately ¼ the size of the suspended ceiling grid. The small size of the fixture permits the use of an ultraviolet and infrared absorbing lens substantially smaller than the size of a lens of a prior-art fixture. In a first preferred embodiment lamps of two different wattages are used in medium screw-base lampholders to provide 3-level operation from two switched circuits.

### BRIEF DESCRIPTION OF THE DRAWINGS

FIG. 1 is a perspective view of a prior-art lay-in troffer for a suspended ceiling, shown for a 2-foot×2-foot ceiling grid;

FIG. 2 is a perspective view of a prior-art lay-in troffer for a suspended ceiling, shown for a 2-foot×4-foot ceiling grid;

FIG. 3 is a perspective view of a strip light fixture for a suspended ceiling, shown over a 2-foot×2-foot ceiling grid;

FIG. 4 is a perspective view of a light fixture for a suspended ceiling according to the invention shown on a 2-foot×2-foot ceiling grid;

FIG. 5 is a longitudinal elevation cross section of the fixture of FIG. 4, taken along section line 5-5;

FIG. 6 is a transverse elevation cross section of the fixture of FIG. 4, taken along section line 6-6; and

FIG. 7 is a cross section of a leg of the fixture of FIG. 4, taken along section line 7-7.

### REFERENCE NUMERALS IN DRAWINGS

| | | | |
|---|---|---|---|
| 1 | prior-art 2 × 2 troffer | 2 | prior-art 2 × 2 housing |
| 3 | 2 × 2 lens | 5 | prior-art 2 × 4 troffer |
| 6 | prior-art 2 × 4 housing | 7 | 2 × 4 lens |
| 10 | ceiling-mount fixture over a grid | 12 | prior-art strip fixture |
| 13 | 4-foot, 40-watt lamps | 14 | T-bar grid pattern |
| 15 | T-bar grid lenses | 20 | fixture per the invention |
| 21 | wireway | 23 | housing |
| 24 | T-bar grid | 25 | depending legs |
| 26 | first lamp | 27 | fasteners |
| 28 | second Lamp | 29 | siffening ribs on Legs |
| 30 | thick lens | 31 | reflector |
| 32 | distal ends of legs | | |

### DETAILED DESCRIPTION OF THE DRAWINGS

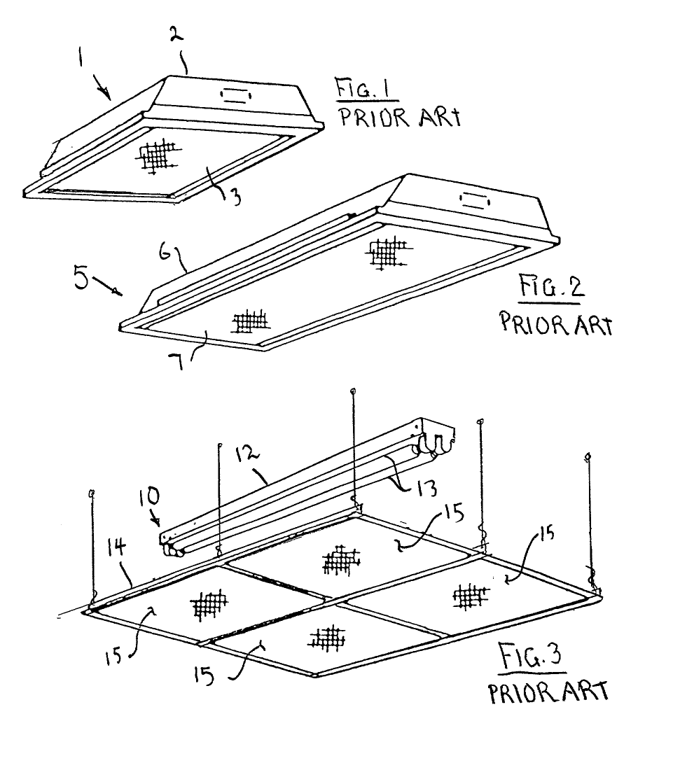

In FIG. 1 a prior-art 2×2 lay-in suspended-ceiling troffer fixture is shown having a housing 2 and a lens 3.

In FIG. 1 a prior-art 2×4 lay-in suspended-ceiling troffer troffer light fixture is shown having a housing 6 and a lens 7.

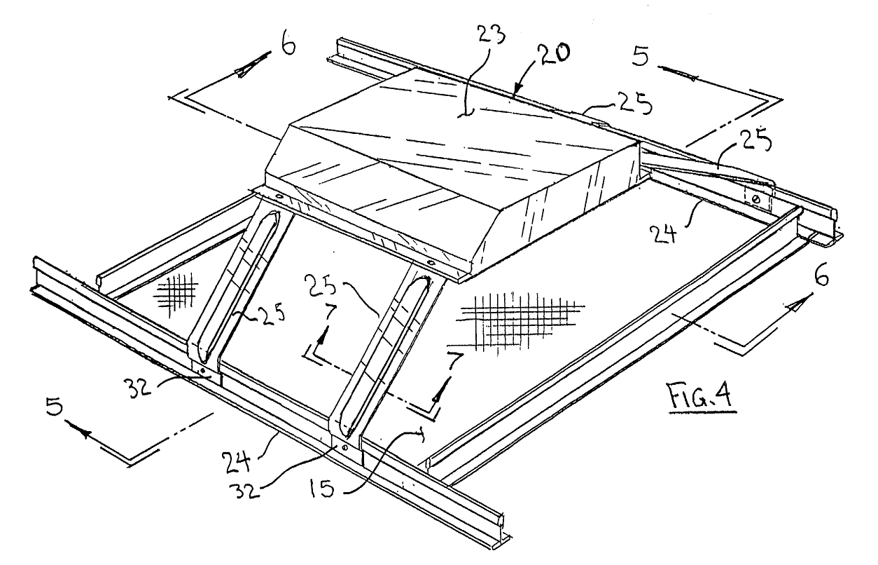

In FIG. 3 a prior-art suspended ceiling lighting system 10 is shown having strip fixture 12 attached to a ceiling above a T-bar grid 14 having a lens 15 in each grid opening.

In FIG. 4 a suspended ceiling lighting system is shown having a fixture 20 according to the present invention, attached to a suspended ceiling grid 24 by a plurality of depending legs 25, terminating in distal ends 32. A lens 15, which may be thin, is shown in the grid opening beneath the fixture.

In FIG. 5 suspended ceiling lighting system 10 is shown having a fixture 20, including a wireway 21, according to the present invention, attached to a suspended ceiling grid 24 by a plurality of depending legs 25 which are attached by fasteners 27. Electrical power may be supplied to the fixture through a conduit attachable to a conduit connector 24. A lens 26 is shown in the grid opening beneath the fixture, and a second lens 30 is shown installed in fixture 20 to provide the thickness required to absorb all ultraviolet and infrared lamp energy. The small dimensions of fixture 20, approximately a 12-inch square in a 14-inch T-bar grid make the thick lens, which is approximately 9-inches×12-inches, practical and inexpensive. First and second lamps, 26 and 28 are shown as compact fluorescent lamps installed in lampholders 22, which may range in power from 5 watts to 26 watts. Thus the fixture can operate on 5 watts, or 26 watts, or 5 plus 26 watts totaling 31 watts. It is possible to install a small quartz-halogen lamp of 25 watts with a 26 watt fluorescent lamp to obtain a compromise of the energy efficiency of a fluorescent lamp with the color rendition of an incandescent halogen lamp.

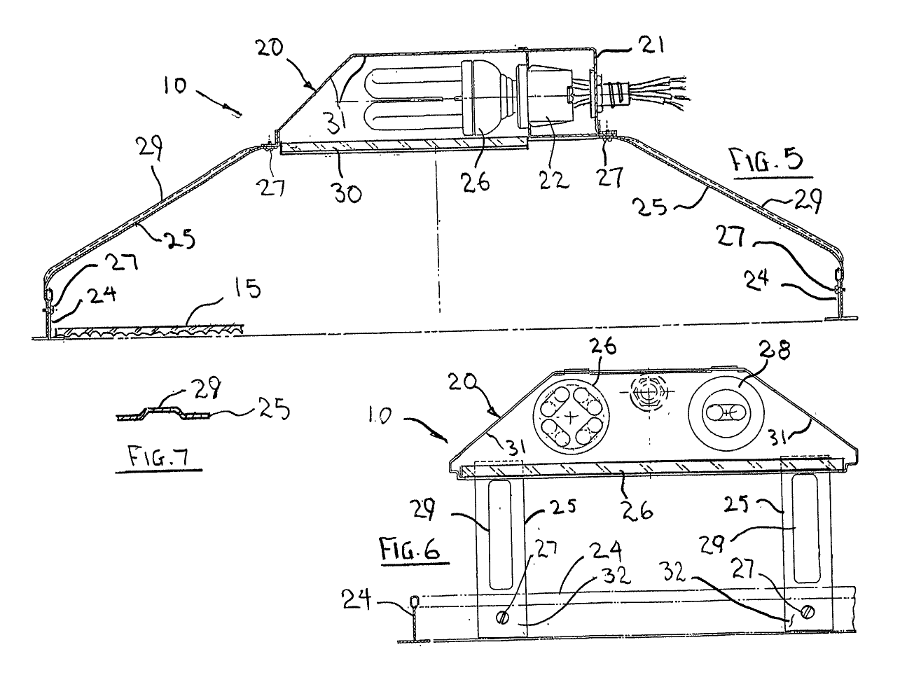

In FIG. 6 the suspended ceiling lighting system 10 is again shown having a fixture 20, according to the present invention, attached to a suspended ceiling grid 24 by a plurality of depending legs 25 which are attached by fasteners 27 to T-Bar grid runners 24. FIG. 6 shows first lamp shown as a four-tube compact fluorescent lamp 26 and a the second single-tube compact fluorescent lamp 28 that is available in 5, 7 or 9 watts. Either or both lamps could be ordinary incandescent lamps, halogen lamps, small metal-halide lamps or even light-emitting diode lamps. The lamps are within a downward-facing reflector 31. Direct and reflected lamp light passes through thick lens 30, which is made of a clear UV and IR absorbing plastic, such as acrylic or polycarbonate.

FIG. 7 shows a cross-section of one of the legs 25, showing a stiffening rib 29 to provide adequate stability for the installed fixture.

### OPERATION, RAMIFICATIONS AND SCOPE

In operation, the fixture according to the present invention provides for a luminous ceiling having uniform luminance through three distinct light levels controlled by either of two light switches or both switches combined. Lamps of different color temperature or different color rendition index may be mixed for illumination where color vision is important.

The depending legs, being removable, can be shipped unattached, whereby a shipping box can be 12×12×3-inches size, or ¼ cubic foot. A typical troffer of 24×24×6 inches would have a volume of 2 cubic feet, which is 8 times the shipping volume and ten times the shipping weight. Also, manufactured product costs vary almost directly with size and weight. Therefore fixtures according to the present invention will be a fraction of the cost of prior-art suspended-ceiling light fixtures.

It will be obvious to anyone skilled in the art that the size and shape of the housing and legs can vary greatly, as well as the lamp complement, and still be within the scope of the invention.

1. A lighting fixture (20) comprising:
a fixture housing (23) comprising a downward-facing concave reflector (31);
a wireway (21) connectable to an external power source;
one or more lampholders (22) for supporting lamps (26, 28) in the reflector and connecting the lamps to the power source; and
elongated legs (25) depending from the fixture housing (23) and having distal ends (32) attachable to T-bar runners (24) in a suspended ceiling grid.

2. A lighting fixture according to claim 1 in which the fixture housing (23) is substantially smaller than the size of the suspended ceiling grid.

3. A lighting fixture according to claim 1 in which the fixture housing (23) is approximately one-fourth the area of the suspended ceiling grid.

4. A lighting fixture (20) according to claim 1 in which the lampholders (22) are medium screw-base lampholders for either incandescent lamps, compact fluorescent lamps or both, said lamps being operable on separately-switched circuits.

5. A lighting fixture according to claim 1 in which the housing (23) includes an ultraviolet and infrared absorbing lens.
